(19) United States
(12) Patent Application Publication
(10) Pub. No.: US 2013/0160744 A1
(43) Pub. Date: Jun. 27, 2013

(54) NEW INTERNAL COMBUSTION ENGINE AT ALTERNATING CYCLE WITH CONTROLLED VARIABLE COMPRESSION RATIO-CVCR

(71) Applicant: Pietro Giovenga, Rome (IT)

(72) Inventor: Pietro Giovenga, Rome (IT)

(21) Appl. No.: 13/261,559

(22) PCT Filed: May 23, 2011
(86) PCT No.: PCT/IT2011/000171

§ 371 Date: Jan. 4, 2013

(30) Foreign Application Priority Data
Jun. 21, 2010 (IT) RM 2010 A000336

(51) Int. Cl. F02B 75/04

(52) U.S. Cl. CPC F02B 75/045
USPC 123/48 B

(57) ABSTRACT

The mechanic system in object uses the new structure of the crank mechanism assembly, for internal combustion engines at alternating cycle, without modifying the cycle. The system, places instead of traditional connecting rod a new system. The system allows using two coaxial pistons with the opposite head, acting in the same cylinder and has opposed combustion chambers. The system then replace the classical three elements for piston (piston, connecting rod and crankshaft), with a system that can be considered to be composed of four elements for two Pistons with an evident general kinematic savings. The salient features of the system are: 1. Reduced lateral piston friction on the cylinder; 2. Reduction of General weights of the crankshaft assembly; 3. Lack of sucking effect resulting in better efficiency; 4. The new system of transmission is composed of two parts. that allows controlling the compression ratio and NOK. The proposed system tends to maintain optimal compression ratio between the volume of air/fuel mixture, and the volume of the combustion chamber 5. The system is governed by a hydraulic circuit, the RC as determined by the program's control unit that controls the real pistons position through an electromagnetic sensors. 6. The system, wanting to get higher specific power, allow to use even the NOK, indeed on the practice experimentation it was found that the RC can significantly exceed the maximum permissible RC which fuel is used, while in a conventional engine, owing to its rigidity, when the NOK happens the piston MUST reach the TDC creating conflicting forces, that create overpressure which tend to lock the engine and compromise its integrity with pressure of more than 200 bar. In the case of the new system these pressures can be controlled keeping them in limits (120/130 bar). 8. The system (which is calculated and prearranged for each specific engine type) in addition to the compression ratio change the intake capacity of Pistons which when the rpm increase make a bigger intake stroke; 9. The decrease of the rotating masses and the symmetrical position of opposed pistons with a cycle of explosions at 90° degrees on the same axis and on the same plane decreases drastically the vibrations of the first level and exclude the need of important stabiliser flywheel for the continuity of the cycle with a reduction of weight and mass; 10. The drive shaft of very small size (⅓ of the conventional drive shaft) decrease twists and longitudinal bending couple reducing vibrations of 2nd level. The small size of drive shaft reduces the couple of rotation of the engine reducing friction and fuel of materials consumption too; 11. The proximity of the cylinder and compactness of the crankshaft involve the reduction of the engine mounting (for 4 Pistons three engine mounting); 12. The placement of the connection point in the new system, changing where the forces of the Pistons are applied to the rod and crankshaft change the characteristics of the engine power, 13. The tiling and using of a single sliding cylinder for two pistons reduces the size of the engine drastically and, whereas practically all the cylinders can be wrapped from the coolant liquid, paradoxically, with a correct cooling system should improve the possibility of lubrication and cooling; 14. The system of electronic ignition must be calibrated in order to optimize the ignition considering the real RC and TDC at the moment of the explosion; The purpose of the new crankshaft Assembly are those of producing engines with reduced fuel consumption, more compact and with torque and power best curves compared to the current engines.

The mechanic system in object uses the structure of the crank mechanism assembly with lever, expressed by the patent GB354781 of 1931 and later taken over by patents DE7908941, U.S. Pat. No. 2383648, FR936514 and U.S. Pat. No. 5025759 for internal combustion engines at alternating cycle, without modifying the cycle. The system, as shown in the drawings attachments (sheet of drawings no. n.. 1,2,3,4,5, 6) places instead of traditional connecting rod a system composed of lever and rod that puts in rotation a crankshaft (sheet of drawings no. n. 1,2,3, part 11). At the top of the lever, which fulcrum (sheet of drawings no. n. 1, part 4, sheet of drawings no. n. 3, part 4; sheet of drawings no. n. 5) are linked in the engine crankcase, with two small rods (sheet of drawings no. n. 1, 2, 3 part 7), two coaxial pistons (Sheet of drawings no. n. 1, 2, 3, 4, part 8) with the opposite head, acting in the same cylinder (Sheet of drawings no. n. 1, 2, 3, part 6) and have opposed combustion chambers. The system then replace the classical three elements for piston (piston, connecting rod and crankshaft), with a system that by connecting two Pistons with a intermediate connection (rods- pistons integral) makes them basically one element in alternating motion, this transmits the motion to a lever that through a connecting rod transmits the motion to the crankshaft. The system can be considered to be composed of four elements for two Pistons with an evident general kinematic savings (integral pistons, lever, rod, and crankshaft). The indicated patents never have been industrised because the engineers have been unable to eliminate the flexions and then the breaking of materials for fatigue. The new system uses a transmission lever composed of two parts: an element elastic that, specifically calculated as two half leaf spring coupled, absorbs the big part of solicitations by limiting efforts to flexion of the rest of the lever that otherwise has a rhomboidal-shaped to give him a substantial rigidity allowing the system to have a long life commercially valid. The rigid part calculated to work specially in compression and traction has at its centre an aperture that allows lying the driving shaft in the symmetrical position referring to the Pistons/lever system. This solution allows to have an engine system extremely balanced and compact.

The salient features of the system are

1. Reduced lateral piston friction on the cylinder and reduced friction on the driving shaft for its minimum size and then for its radial reduced speed;

2. Reduction of General weights of the crankshaft assembly, for the drastic reduction of the size of the driving shaft and for the reduction of pieces not only in number but also in size;

3. Lack of sucking effect resulting in better efficiency;

4. the transmission lever is composed of two parts (sheet of drawings no. n. 5 and 6), the part linking to the fulcrum and the connecting rod, which transmits the motion to the crankshaft, which due to the particular rhomboidal-shaped gives a substantial stiffness and lightness to the system (Sheet of drawings no. n. 5, part 9), the second part is linking pistons (sheet of drawings no. n. 5, part 10) this is flexible and consists of two half leaf spring coupled, it absorbs a big part of the Pistons pulses limiting suitably the flexions of the rest of the system. The flexions of the second part of the lever are the cause of the change compression ratio (RC). in proportion to vary the number of engine revolutions for the approach, because of the inertia forces, of the Pistons to the top of the combustion chamber, reducing its volume. This phenomenon without an effective control system makes it unusable as previously thought. The new system uses the flexibility in their favour. The flexibility of elastic part is controlled by two lateral standstills (Sheet of drawings no. n.s 5 and 6. part 13) that limit deformation within the permissible maximum deflection of materials not allowing the transition from elastic to plastic phase. The flexion is controlled by some hydraulic pistons, they are inside of the lateral standstill (sheet of drawings no. n. 6 part 12) or near the fulcrum of the lever (sheet of drawings no. n. 8)and they limit the flexion amplitude of the elastic part allowing to modify and check the compression ratio (RC) for each cycle of the engine when appear the NOK (combustion shock). The mathematic compression ratio change when the piston stroke change and the real compression ratio change constantly, depending on the volume of air and fuel is coming in the cylinder, if an engine works with the carburettor throttle not completely open the real compression ratio decreases decreasing dramatically the engine efficiency and increasing pollution for the bad combustion of gas shortly compressed and then burnt with a wave of combustion slower, that undermines the same complete combustion. The system can works also without the elastic element , but need of a system to move the fulcrum of lever as in sheet of drawings n.9. In this case the bloc where the fulcrum of lever is inside can be moved by hydraulic pistons or cams of eccentric axis. The proposed system tends to maintain optimal compression ratio between the volume of air/fuel mixture, and the volume of the combustion chamber, this contributes to a significant improvement of volumetric efficiency of the engine to the medium and high rpm with a major improvement of the torque curve. The control of RC need when under the request of more powerful from the engine when there is a substantial full coverage of cylinders, the RC tends to exceed the maximum limit allowed by specific fuel giving away to the NOK. The variation of the compression ratio is controlled by a control unit (sheet of drawings no. n. 7) that receives the value of the real pressure in the combustion chamber through a piezoelectric crystal silicon which solicited by the pressure itself emits an electrical impulse that one change in the presence of NOK, the control unit operates in a way as to decrease the RC and other parameters such as the ignition spark plug advance.

5. The hydraulic Pistons are governed by a hydraulic circuit through the lever base near of the pin (practically the axis of the fulcrum is stationary) the oil goes through the steel tube up to the lateral standstill and the pistons positioning themselves as determined by the program's control unit that controls the real pistons position through an electromagnetic sensors (sheet of drawings no. n. 7).

6. the variation of the compression ratio allows to have the optimal compression ratio decreasing it when the cylinder filling is more complete at low rpm and an increasing it in the high rpm when the cylinder filling shall not exceed 60-70%, that allow to optimising the torque curve, power, with the reduction in consumption and pollution at all rpm;

7. the system, wanting to get higher specific power, allow to use even the NOK, indeed on the practice experimentation it was found that the RC can significantly exceed the maximum permissible RC which fuel is used, while in a conventional engine, owing to its rigidity, when the NOK happens the piston MUST reach the TDC creating conflicting forces, that create overpressure which tend to lock the engine and compromise its integrity with pressure of more than 200 bar. In the case of the described system these pressures can be controlled keeping them in limits (120/130 bar) because the elastic element allows to the piston to start his way back while the lever completes its mandatory cycle until his TDC and returns the stored energy elastically immediately after (the whole thing is in the space of tenths of millimetres and in times of milliseconds), increasing incredibly power output and the fluidity of itself with a further improvement of consumption and the reduction of pollution. This phenomenon happens because the increasing of RC and when start the NOK a first flaming front of combustion lag start and that immediately after is followed by the second flaming front ignited by the spark plug. The two flaming fronts, together increase the pressure and allow a much faster blast in the combustion chamber that becomes into a much strong boost that passes from 80 bar to 120/150 bar with the same fuel and then with a significant greater efficiency.

8. The Flexion (which is calculated and prearranged for each specific engine type) in addition to the compression ratio change the intake capacity of Pistons which when the rpm increase make a bigger intake stroke;

9. the decrease of the rotating masses and the symmetrical position of opposed pistons and levers (sheet of drawings no. n. 1, 2, 3, 4) with a cycle of explosions at 90° degrees on the same axis and on the same plane decreases drastically the vibrations of the first level and exclude the need of important stabiliser flywheel for the continuity of the cycle with a reduction of weight and mass;

10. The drive shaft of very small size (⅓ of the conventional drive shaft) decrease twists and longitudinal bending couple reducing vibrations of 2nd level. The small size of drive shaft reduces the couple of rotation of the engine reducing friction and fuel of materials consumption too;

11. The proximity of the cylinder and compactness of the crankshaft (sheet of drawings no. n. 2, part 11) involve the reduction of the engine mounting (for 4 Pistons three engine mounting) (sheet of drawings no. n. 2, part 14);

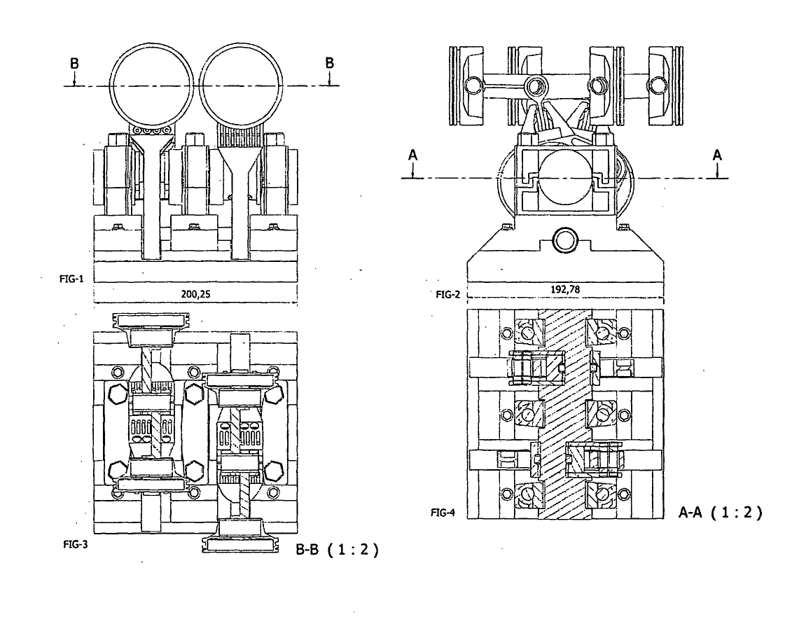

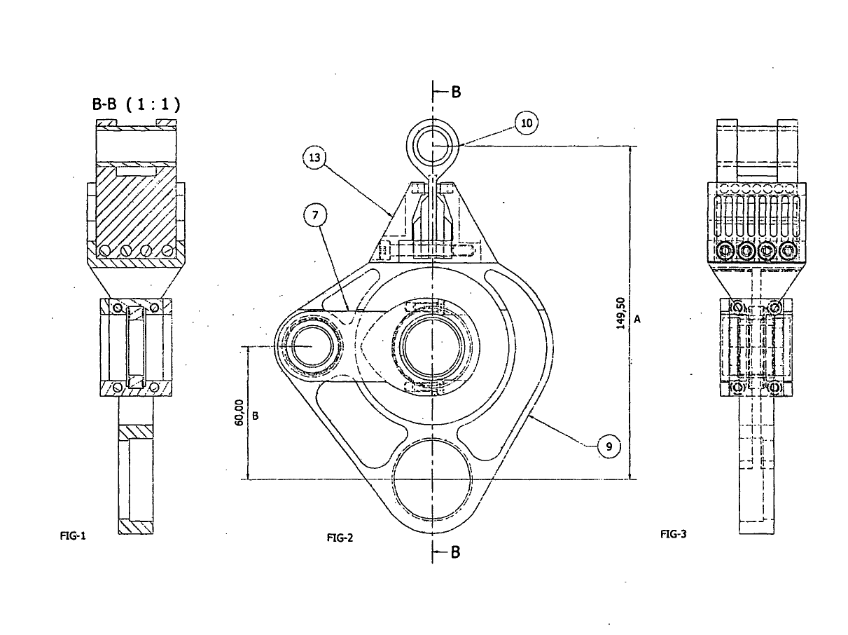

12. the placement of the connection point of the connecting rod lever (sheet of drawings no. n. 5, FIG. 2, dimensions A and B), changing the ratio of (A) to (B) , the forces of the Pistons are applied to the rod and crankshaft in different way, changing the characteristics of the engine power; 13. the tiling and using of a single sliding cylinder for two pistons reduces the size of the engine drastically and, whereas practically all the cylinders can be wrapped from the coolant liquid, paradoxically, with a correct cooling system should improve the possibility of lubrication and cooling;

14. The system of electronic ignition must be calibrated in order to optimize the ignition considering the real RC and TDC at the moment of the explosion; The purpose of the new crankshaft Assembly are those of producing engines with reduced fuel consumption, more compact and with torque and power best curves compared to the current engines.

How could be calculated the elastic part of the lever:

The process used for dimensioning the elastic leaf spring part of the lever supporting the rod engine is the following:

1) Calculating the surface quadratic moment at fixed end of called section J (mm \hat{+}4) of the single plate that subsequently will be divided into more strips.

By definition, J=(P*Î3)/(2*E*F) where J is expressed in mm ̂4

With P=load applied (N)

L1=length of the plate (mm)

E=flexural modulus of elasticity. In steels is approximately 21000 N/mm ̂2.

F=camber (mm)

2) once calculated J, surface quadratic moment at fixed end of the plate section, it is possible evaluate the thickness of plate H taking as σ permissible for dynamic stress as that applied to our leverage, equal at 0.4 σ yield strength. Consider that for a stainless steel the yield strength is approximately 1050 N/mm ̂2.

H=(2*σ permissible*J)/(P*L) (mm)

Where: j=surface quadratic moment at fixed end of the plate section at the joint. (mm ̂4).

σ permissible=1.4 σ yield strength (N/mm ̂2)

P=load applied (N)

L=length of the plate (mm)

3) at this point is possible to calculate the maximum width B of the triangular plate using the following formula:

B=(12*J)/Ĥ3

Where J=surface quadratic moment at fixed end of the plate section at the joint. (mm ̂4).

H=the thickness of the plate (mm).

Once the above parameters are calculated the plate is “theoretically” dimensioned.

To get the real leaf spring must subdivide the triangular theoretical plate in a series of strips that will then overlapped.

Consulting the UNI3960 specifications it is possible to evaluate the combination of real strips correctly sized in relation to the parameters calculated above.

For our leaf spring the calculation must consider the element formed by two “leaf spring systems” that will have in common the longer centrepiece that one under stress will involve the shorter left or right plates independently of each other with symmetric and opposed loads.

4) once the real sizing of leaf spring is known is possible to proceed with a control by evaluating the real agent load applied on the trapezoidal plate considering the number of strips and hits sizes obtained:

For the calculation of the real load on the single strips agent is possible to use the following formula:

σ=(6*P*L)/(n*b*Ĥ2)

where P=load applied (n)

L=length of the plate (mm)

b=width of the plate (mm)

H=the thickness of the plate (mm)

n=number of strips

for the calculation of real-camber it is possible to use the formula:

f=η*(4*P*LÂ3)/(E*n*B*Ĥ3)

These are all coefficients known except η=b′/b where b′ is the width of the single strips and where b is the width of all the strips.

Dimensioned and verified statically the leaf spring, this must be verified al fatigue strength to determine the strength of the elastic element over time.

To have the theoretically unlimited elastic loading cycle of the item the data value should remain within the diagram of Goodman Smith.

Fixed material characteristics:

σ yield strength for a stainless steel the yield strength is approximately 1050 N/mm ̂2.

Δσ that in alloy still is equal to about 300N/mm ̂2.

It is possible calculate the diagram of fatigue strength and the security level considering the distance of the summit of sinusoidal loading cycle curve from the limit determined by Goodman Smith diagram indicating the limit load cycle.

### DRAWINGS

1. sheet of drawings no. n. 1: new internal combustion engine at alternating cycle with controlled variable compression ratio: overview of an engine two cylinders and 4 pistons with the new crankshaft assembly and devoid of cylinder head that remains traditional;

2. sheet of drawings no. n. 2: new internal combustion engine at alternating cycle with controlled variable compression ratio: views with transparency of front (view respect to the axis of the drive shaft) and from above of an engine 4 pistons and two cylinders with the new crankshaft assembly with section vertical at the engine base and the centreline of the drive shaft;

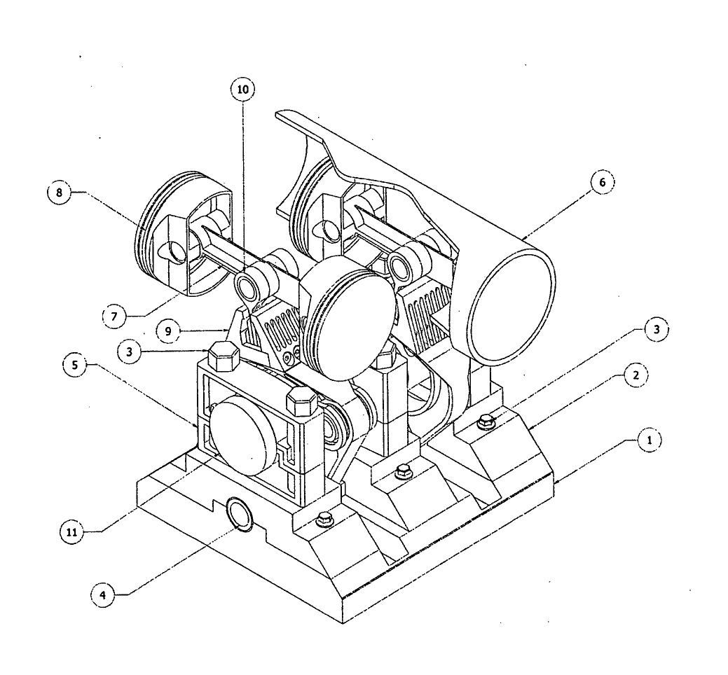

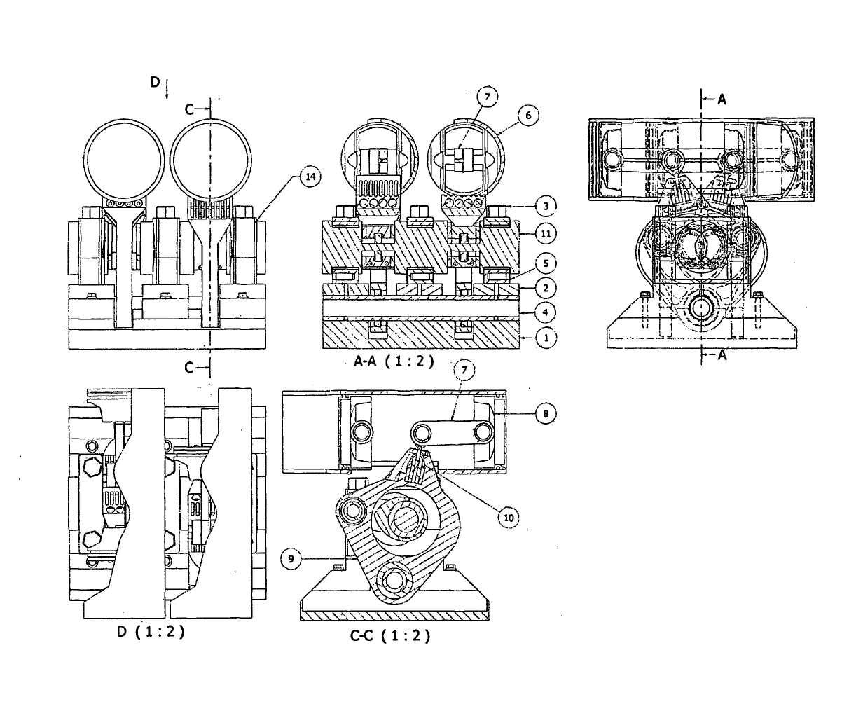

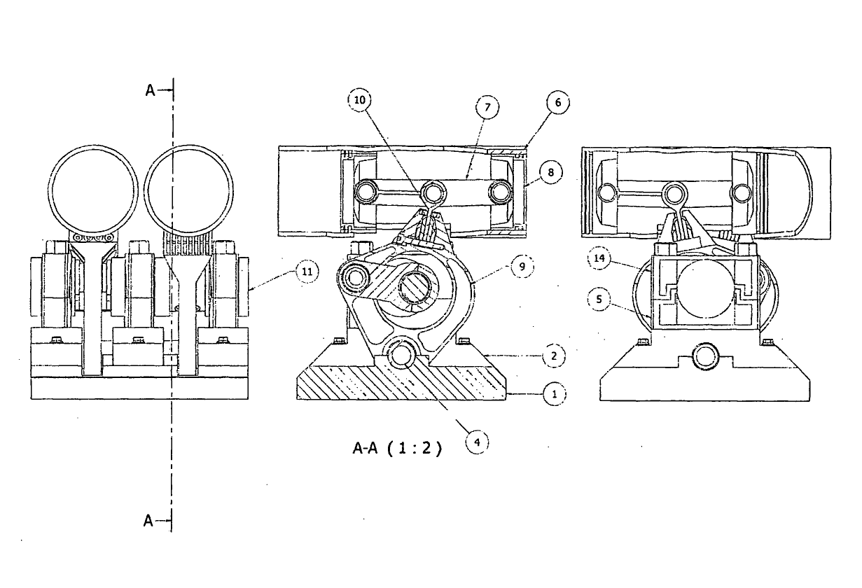

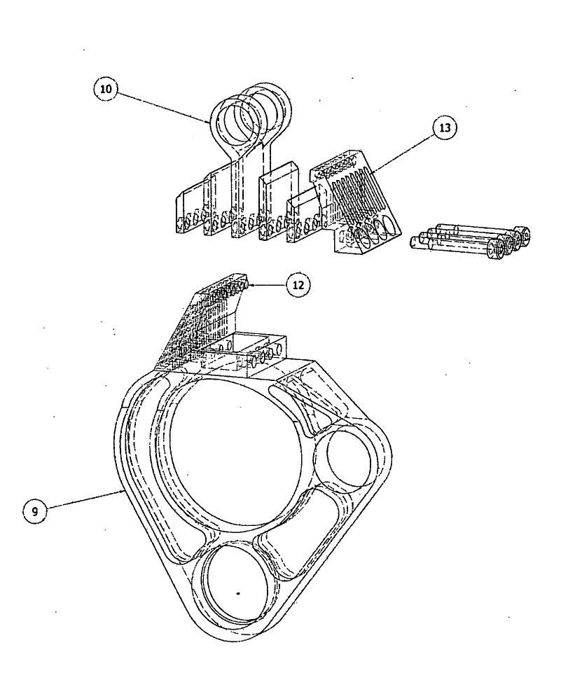

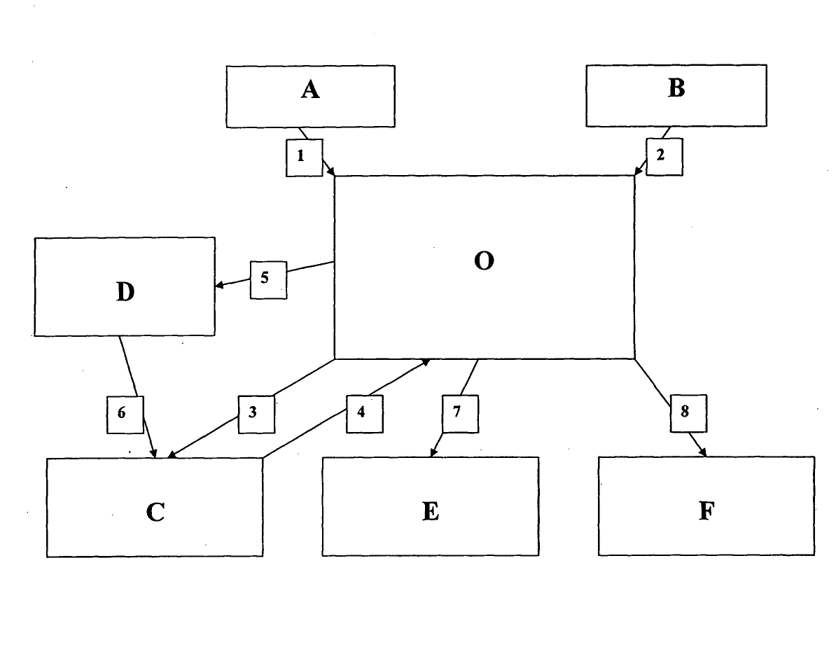

3. sheet of drawings no. n. 3: new internal combustion engine at alternating cycle with controlled variable compression ratio: front views (FIG. 3) (view respect to the axis of the drive shaft) and lateral view (FIG. 1) of an engine two cylinders and 4 pistons with the new crankshaft assembly with vertical section (FIG. 2) to the engine base and perpendicular to the axis of the drive shaft;

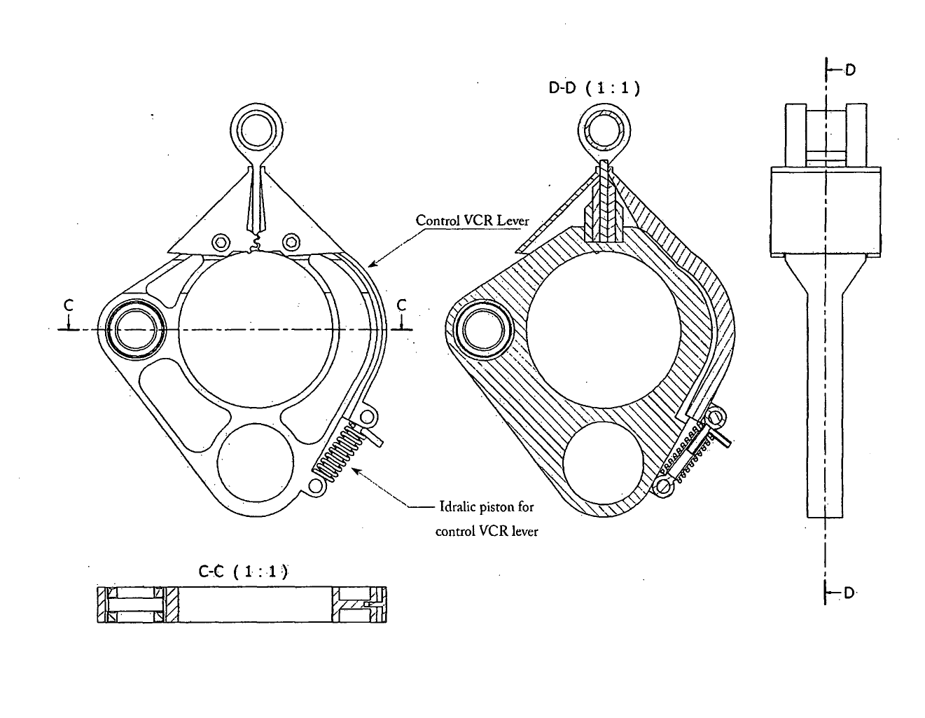

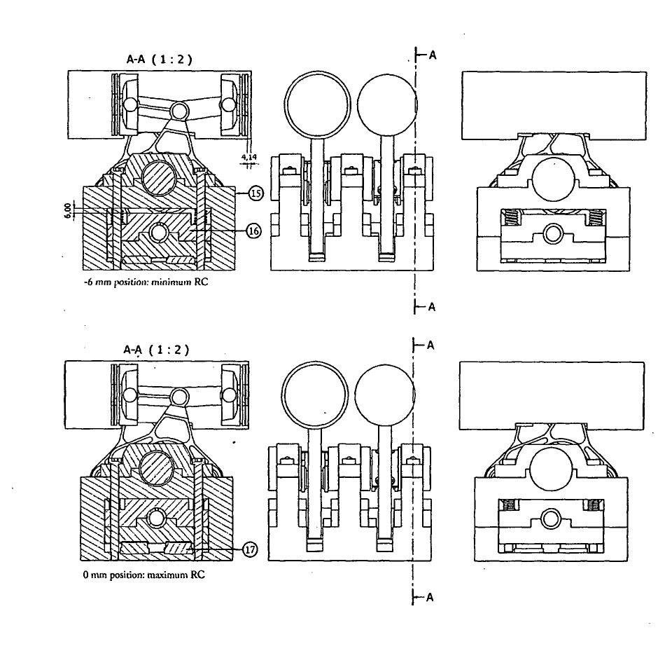

4. sheet of drawings no. n. 4: new internal combustion engine at alternating cycle with controlled variable compression ratio: views with indicative measures of an engine 4 pistons and two cylinders (approximately 1000 cc), (FIG. 1) section vertical at the engine base of the crankshaft axis, (FIG. 2) front view (respect to the axis of the drive shaft) and (FIG. 3) horizontal section parallel to the engine base on the axis of the cylinder, (FIG. 4) horizontal section parallel to the engine base of the crankshaft axis;

5. sheet of drawings no. n. 5: new internal combustion engine at alternating cycle with controlled variable compression ratio: cross-section (FIG. 1) and prospectuses (FIGS. 2, 3) of the lever and the rod for the transmission of motion to the crankshaft engine two cylinders and 4 pistons with the new crankshaft assembly and RC variation system;

6. sheet of drawings no. n. 6: new internal combustion engine at alternating cycle with controlled variable compression ratio: exploded of the transmission lever assembly of the motor shaft of an engine 4 pistons and two cylinders with the new crankshaft assembly and RC variation system;

7. sheet of drawings no. n. 7: new internal combustion engine at alternating cycle with controlled variable compression ratio: Schematic of electronic control system of the engine:
a. o unit of electronic control
b. a: Piezoelectric sensor situated in the combustion chamber to monitor the pressure generated by fuel explosion.
c. b: carburettor throttle
d. c: hydraulic pistons situated on the lever to control the elastic deflection in order to monitor and manage the RC. The position of the hydraulic piston is monitored by electromagnetic sensors managed by the unit controller.
e. D: command of hydraulic pump for control of the lever elastic element deflection .
f. e: electronic injection system.
g. f: electronic ignition system
h. cycle of actions of the control system:
   1) impulse of sensor A the unit controller o,
   2) reporting of the opening of the throttle b to O,
   3) the unit controller o controls the position of the hydraulic piston c,
   4) the unit controller receives the position of the piston,
   5) the unit controller sends a command to the hydraulic pump
   6) the unit controller positions the hydraulic pistons according to the data given by the sensor in the program default to have the correct RC need at that moment,
   7) simultaneously with RC the unit controller change the time of ignition,
   8) simultaneously the unit controller changes the times and the amount of fuel injection in the cylinder.
   8. sheet of drawings no. n. 8: new internal combustion engine at alternating cycle with controlled variable compression ratio: example of a different mode of application for the lever RC control;
   9. sheet of drawings no. n. 9: new internal combustion engine at alternating cycle with controlled variable compression ratio: example of a different mode of application for the lever RC control with the mobile base of the lever fulcrum;

### LEGEND OF THE SHEET OF DRAWINGS NO. N.S:

Part 1: engine base

Part 2: Block basic engine pin

Part 3: tightening bolts of crankcase that supports the lever fulcrum and the drive shaft.

Part 4: Pin engine base

Part 5: bottom engine shaft

Part 6: cylinder

Part 7: rod of piston

Part 8: piston

Part 9: rigid lever component to transfer motion

Part 10: flexible component lever to transfer motion

Part 11: drive shaft

Part 12: hydraulic pistons

Part 13: standstill to control the lever elastic element deflection

part 14: upper support of the drive shaft

part 15: crank case of engine with mobile base of the lever fulcrum

part 16: mobile base of the lever fulcrum

part 17: hydraulic pistons or cams of eccentric axis.

BIBLIOGRAPHY of elastic part calculations

[1] G. Caligiana, A. Liverani, S. Pippa, “Modelling, design and analysis of a testing rig for composite materials”, XIII ADM—XV INGEGRAF International Conference on Tool and Methods Evolution in Engineering Design, Napoli-Salerno, 2003, pp. 1-10 (atti).

[2] R. Talreja, J-A. E. Manson, Comprehensive Composite Materials, Polymer matrix composites, Vol. 2, A. Kelly and C. Zweben Editors, Elsevier, 2000 (book).

[3] T. J. Reinhart et alii, Composites, Engineering Materials Handbook, Vol. 1, ASM International, Metal Park, Ohio 44073, 1998 (book).

[4] K. K. Chawla, Composite Materials, Science and Engineering, Springer-Verlag New York, U.S.A., 1998 (book).

[5] Mel M. Schwartz, Composite Materials, Properties Nondestructive Testing, and Repair (Vol. I), Processing, Fabrication and Applications (Vol. II), Prentice Hall PTR Upper Saddle River, N.J., U.S.A., 1997 (book).

[6] I. M. Daniel, O. Ishai, Engineering Mechanics of Comosite Materials, Oxford University Press, New York, 1994 (book).

[7] M. Reyne, Technologie des composites, Hermes, Paris, 1990 (book).

[8] G. Caligiana, F. Cesari, I materiali compositi, Pitagora Editrice, Bologna, 2002 (book).

[9] ASTM, STP 1242, Composite materials : Testing and Design, Thirteenth Volume, S. J. Hopper editor., West Conshohocken, Pa., U.S.A., 1997 (book).

[10] ASTM, STP 1274, Composite materials : Testing and Design, Twelfth Volume, R. B. Deo, C. R. Saff editors, West Conshohocken, Pa., U.S.A., 1996 (book).

1. Internal combustion engine at alternating cycle with controlled variable compression ratio (CVRC). Including: rhomboidal lever positioned with the fulcrum fixed on the engine crankcase through a connecting horizontal axis on which are placed swished of drawings no bearings for the oscillation of the lever. The head of the lever are connected to the pistons through connecting rods and traditional pins that allow its swing during the completion of the arc described by the head of the leverage during its movement. The head of leverage is positioned on the centerline distance between the piston in side of the cylinder in which they slide (Sheet of drawings no 2). The lever is composed of two essential parts; a rhomboidal-shaped rigid part and an elastic part, formed by two half leaf spring, with the system controlling and limiting the elastic flexion (Sheet of drawings no 6). It is characterized by: The complex of crankshaft assembly is characterized by the presence of the elastic part and the rigid rhomboidal-shaped part, that allows the positioning of the drive shaft on the vertical axis of the fulcrum of the lever and allows to have the movement of the pistons slightly not in phase of displacement angle compared to the movement of the lever and crankshaft. This difference in phase is caused to the elastic element, it allow to vary the real compression ratio (RC) of the engine when is varying the conditions of use the engine and the opening of the throttle of the carburetor of the engine. The flexion of the elastic part is limited by two standstills on both side of it, the standstill are included in the rigid part of the lever. The standstill support a number of hydraulic pistons, that can block completely the flexion of the elastic part obtaining the minimum compression ratio calculated by the project of the specific engine the use of different parameters allows having engines with different characteristics. The engine with the variation of the RC is controlled by a unit controller computer that informed by a piezoelectric sensor silicon inside the combustion chamber of the engine, send the value of pressure that is generated of each combustion cycle of the engine, if the pressure is too low the unit controller, which senses the position of the pistons through the electromagnetic sensors placed in the standstill, moving the hydraulic pistons through the reduction of oil pressure in its hydraulic system allows more flexion of the elastic part. That increases the piston stroke and decreases the volume of the combustion chamber obtaining the desired higher RC as from project of the specific engine. If the RC is too high the unit controller makes the inverse operation by increasing the hydraulic pressure in the hydraulic pistons reducing the flexion of the elastic part decreasing the RC.

2. Internal combustion engine at alternating cycle with controlled variable compression ratio (CVRC). How to claim 1, the system is characterized by the fact that the elastic element, in high efficiency engines, Allow to use the NOK (combustion shock) due to pre-combustion of the mixture in the presence of an RC too high for a given fuel . This phenomenon in conventional engines will lock the engine might even compromising its integrity. The new engine can use the phenomenon of NOK to benefit of more power, less pollution and less fuel consumption. Indeed, while in a conventional engine happens the NOK the piston is forced to reach the top dead center (TDC) opposing to the pressure created by pre-combustion of the mixture, reaching pressures of 200 bar, in the new engine the elastic element, in fractions of millimeters and milliseconds allows the piston to begin its return stroke just before TDC, allowing the rigid part of lever to complete the cycle through its TDC without coming to destructive pressures but allowing the use of excessive pressure. More energy is generated by accumulating it in the elastic element that returns to the engine immediately after passing TDC rigid lever. In this new cycle is given a further advantage due to the spark ignition immediately afterwards the NOK. In the combustion chamber will have two flame fronts, this phenomenon accelerates the burning times increasing the pressure thrust , with make more torque and power engine with the same quantities of fuel, that reduce fuel consumption and pollution with the equal power.

3. Internal combustion engine at alternating cycle with controlled variable compression ratio (CVRC). How to claim 1, the new engine is characterized in that:
The engine has a control system whose core consists of an electronic unit control computer that regulates the RC decoding the pulse, varying with the pressure changes, given from a piezoelectric silicon sensor inside the combustion chamber of the engine and the sensor located in the carburetor that gives the amount of throttle opening that determines the flow of air into the cylinder. When the impulses communicated to the unit control change it operates through a hydraulic pump on the hydraulic pistons, that determine the deflection of the elastic lever connecting rods, varying the RC. Simultaneously to the variation of the parameters mentioned, the unit controller varies the advance ignition engine, the amount and timing of fuel injection. If the engine is designed to support higher combustion pressures than the unit manages the phenomenon of NOK allowing and controlling the pressures generated within the project limits.

4. Internal combustion engine at alternating cycle with controlled variable compression ratio (CVRC). How to claim 1, the new engine is characterized in that: has an electronic control system that manages the cycle as described below: the value of pressure pulses in the combustion chamber and the carburetor throttle position are received and processed by a unit controller in the parameters included in the project program, the unit controller monitors the position of hydraulic piston and reposition them, acting on a hydraulic pump for maximum RC allowed from the project, while managing the advance of the ignition and the amount and timing of fuel injection.
